(19) United States
(12) Patent Application Publication
(10) Pub. No.: US 2014/0168472 A1
(43) Pub. Date: Jun. 19, 2014

(54) IMAGE PICKUP DEVICE

(71) Applicant: OLYMPUS CORPORATION, Tokyo (JP)

(72) Inventors: Tomoyuki Sengoku, Tokyo (JP); Akira Ueno, Tokyo (JP); Yoshinobu Tanaka, Tokyo (JP); Takashi Yanada, Tokyo (JP)

(73) Assignee: OLYMPUS CORPORATION, Tokyo (JP)

(21) Appl. No.: 14/096,349

(22) Filed: Dec. 4, 2013

(30) Foreign Application Priority Data
Dec. 18, 2012 (JP) 2012-276158

(51) Int. Cl. H04N 5/76; H04N 5/265; H04N 5/232

(52) U.S. Cl. CPC H04N 5/76; H04N 5/23293; H04N 5/265
USPC 348/231.99

(57) ABSTRACT

An image pickup device includes an image data interface unit outputting image data corresponding to an input pixel signal as first image data, a first image data writing unit causing a storage unit to store image data based on the first image data via a data bus, a first image data reading unit reading the image data stored in the storage unit via the data bus and outputting the read image data as second image data, an image combining unit generating and outputting third image data by combining two pieces of input image data, a second image data writing unit causing the storage unit to store the third image data via the data bus; and a display unit reading the image data stored in the storage unit from the storage unit via the data bus and displaying an image corresponding to the read image data.

### BACKGROUND OF THE INVENTION

1. Field of the Invention

The present invention relates to an image pickup device.

Priority is claimed on Japanese Patent Application No. 2012-276158, filed Dec. 18, 2012, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

When an image pickup device photographs a subject required to be exposed for a long time such as starry sky, fireworks, or a night view, a bulb photographing function provided in the image pickup device is usually used. When the bulb photographing function is used, a user of the image pickup device (a photographer) performs an operation of opening the shutter for an arbitrary period of time. Thereby, an image exposed for a time in which the shutter has been opened is captured. FIG. 9 is a diagram illustrating a relationship between an exposure time and a captured image in the image pickup device. As illustrated in FIG. 9, the captured image sequentially transitions from an insufficient exposure state to an excessive exposure state in association with the passage of the exposure time.

It is difficult to check a current exposure state in the image pickup device of the related art. Thus, the adjustment of the exposure time significantly depends on the sense of the photographer. It is not always true that an image can be captured at a desired exposure level. For example, in FIG. 9, an image Y of the insufficient exposure state rather than the desired exposure level is captured if the shutter is released (closed) early when an image X of the desired exposure level is configured to be captured. In addition, an image Z of the excessive exposure state rather than the desired exposure level is captured if the shutter fails to be released (is too open).

In Japanese Unexamined Patent Application, First Publication No. 2005-117395, technology capable of checking an exposure level of an image in real time while checking a monitor provided in the image pickup device when the bulb photographing function is used is disclosed. In this technology, captured images of respective frames generated for a predetermined exposure time are sequentially added and respective frame images (hereinafter referred to as “cumulative added images”) generated by adding the images are sequentially displayed on the monitor. Thereby, the cumulative added image is updated and displayed in real time while an exposure process is performed using the bulb photographing function. Thereby, the photographer can easily release the shutter at an intended exposure level.

FIG. 10 is a diagram schematically illustrating an example of an operation in which an image pickup device of the related art displays a cumulative added image while capturing an image. In FIG. 10, an example in which the image pickup device sequentially displays cumulative added images obtained by cumulatively adding captured images of respective frames on the monitor while capturing ten captured images is illustrated. In FIG. 10, when the image pickup device has captured an eighth captured image, a photographing stop instruction indicating a shutter timing intended by the photographer is issued. According to the photographing stop instruction, the image pickup device of the related art records cumulative added images obtained by cumulatively adding first to eighth captured images displayed on the monitor at the shutter timing.

### SUMMARY

According to a first aspect of the present invention, an image pickup device includes an image data interface (I/F) unit which outputs image data corresponding to a pixel signal input from a solid-state image pickup device as first image data; a first image data writing unit which causes a storage unit to store image data based on the first image data via a data bus; a first image data reading unit which reads the image data stored in the storage unit via the data bus and outputs the read image data as second image data; an image combining unit which generates and outputs third image data by combining two pieces of input image data; a second image data writing unit which causes the storage unit to store the third image data via the data bus; and a display unit which reads the image data stored in the storage unit from the storage unit via the data bus and displays an image corresponding to the read image data.

According to a second aspect of the present invention, in the image pickup device according to the first aspect, after an instruction to start image capturing by the solid-state image pickup device has been issued, the image data I/F unit may sequentially output a plurality of pieces of the first image data corresponding to pixel signals of respective frames sequentially input from the solid-state image pickup device, the first image data writing unit may cause the storage unit to sequentially store image data based on the first image data of the respective frames sequentially output from the image data I/F unit, the first image data reading unit may sequentially read the third image data, which is generated by the image combining unit and ultimately stored by the second image data writing unit in the storage unit, continuous to image data based on the first image data of a first frame stored in the storage unit, as the second image data, the image combining unit may sequentially output the third image data obtained by sequentially adding and combining image data based on the first image data sequentially output from the image data I/F unit and image data based on the second image data sequentially read by the first image data reading unit, the second image data writing unit may cause the storage unit to sequentially store the third image data sequentially output from the image combining unit, and the display unit may sequentially display images corresponding to the third image data generated by the image combining unit and stored by the second image data writing unit in the storage unit.

According to a third aspect of the present invention, the image pickup device according to the second aspect may further include a second image data reading unit which reads image data, which is different from the image data read by the first image data reading unit from the storage unit, from the storage unit via the data bus and outputs the read image data as fourth image data, wherein the storage unit stores image data based on the first image data of all frames sequentially output from the image data I/F unit during a period in which the solid-state image pickup device has performed image capturing and sequentially stored by the first image data writing unit and wherein, after an instruction to stop image capturing by the solid-state image pickup device has been issued, the first image data reading unit reads image data based on the first image data of one frame stored in the storage unit as the second image data, the second image data reading unit reads image data based on the first image data of the next frame of the image data based on the first image data read by the first image data reading unit or the third image data generated by the image combining unit and ultimately stored by the second image data writing unit in the storage unit as the fourth image data, the image combining unit outputs the third image data obtained by adding and combining image data based on the second image data read by the first image data reading unit and image data based on the fourth image data read by the second image data reading unit, and the display unit displays an image corresponding to the third image data generated by the image combining unit and stored by the second image data writing unit in the storage unit.

According to a fourth aspect of the present invention, the image pickup device according to the second aspect may further include a second image data reading unit which reads image data, which is different from the image data read by the first image data reading unit from the storage unit, from the storage unit via the data bus and outputs the read image data as fourth image data, wherein, when an instruction to stop image capturing by the solid-state image pickup device has been issued, the storage unit stores image data based on the first image data of a frame output from the image data I/F unit and stored in the storage unit, image data based on the first image data of a predetermined number of frames output from the image data I/F unit and stored in the storage unit in periods before and after the image capturing stop instruction has been issued, and the third image data obtained by the image combining unit sequentially combining image data from image data based on the first image data of a first frame stored in the storage unit after the instruction to start the image capturing by the solid-state image pickup device has been issued to image data based on the first image data of a frame one frame before a predetermined number of frames in a period before the instruction to stop the image capturing is issued, and wherein, after the instruction to stop the image capturing by the solid-state image pickup device has been issued, the first image data reading unit reads image data based on the third image data stored in the storage unit or the first image data of one frame as the second image data, the second image data reading unit reads image data based on the first image data of a first frame stored in the storage unit or image data based on the first image data of the next frame of image data based on the first image data read by the first image data reading unit as the fourth image data, the image combining unit outputs the third image data obtained by adding and combining image data based on the second image data read by the first image data reading unit and image data based on the fourth image data read by the second image data reading unit, and the display unit displays an image corresponding to the third image data generated by the image combining unit and stored by the second image data writing unit in the storage unit.

According to a fifth aspect of the present invention, the image pickup device according to the second aspect may further include a second image data reading unit which reads image data, which is different from image data read by the first image data reading unit from the storage unit, from the storage unit via the data bus and outputs the read image data as fourth image data, wherein the storage unit stores the third image data obtained by the image combining unit sequentially combining image data from image data based on the first image data of a first frame stored in the storage unit after an instruction to start image capturing by the solid-state image pickup device has been issued to image data based on the first image data of a frame output from the image data I/F unit and stored in the storage unit when an instruction to stop the image capturing by the solid-state image pickup device has been issued and the third image data of a predetermined number of frames obtained by the image combining unit sequentially combining image data from image data based on the first image data of the first frame to image data based on the first image data of the predetermined number of frames output from the image data I/F unit and stored in the storage unit in periods before and after the instruction to stop the image capturing has been issued, and wherein, after the instruction to stop the image capturing by the solid-state image pickup device has been issued, the first image data reading unit reads the third image data of one frame stored in the storage unit as the second image data, the second image data reading unit reads the third image data of a different frame from that of the third image data read by the first image data reading unit as the fourth image data, the image combining unit outputs the third image data obtained by subtracting and combining image data based on the second image data read by the first image data reading unit and image data based on the fourth image data read by the second image data reading unit, and the display unit displays an image corresponding to the third image data stored in the storage unit or an image corresponding to the third image data generated by the image combining unit and stored by the second image data writing unit in the storage unit.

According to a sixth aspect of the present invention, the image pickup device according to any one of the third to fifth aspects may further include a first pre-processing unit which performs a predetermined process on input image data; a second pre-processing unit which performs a predetermined process on input image data; and a third pre-process unit which performs a predetermined process on input image data and has the same configuration as the second pre-processing unit, wherein the first pre-processing unit outputs image data obtained by performing the predetermined process on the input first image data as image data based on the first image data, wherein the second pre-processing unit outputs image data obtained by performing the predetermined process on the input second image data as image data based on the second image data, and wherein the third pre-processing unit outputs image data obtained by performing the predetermined process on the input fourth image data as image data based on the fourth image data.

According to a seventh aspect of the present invention, in the image pickup device according to the sixth aspect, the first pre-processing unit may be at least one processing unit which performs a predetermined correction process on input image data, and the second and third pre-processing units may include at least one delay unit which performs a process of delaying input image data by a predetermined time and outputting the delayed input image data.

According to an eighth aspect of the present invention, in the image pickup device according to the seventh aspect, the predetermined time may be the same as a delay time until an output obtained by performing the predetermined correction process is generated after image data is input to the first pre-processing unit.

According to a ninth aspect of the present invention, in the image pickup device according to the sixth aspect, the first pre-processing unit may be at least one first processing unit which performs a predetermined correction process on input image data, and the second and third pre-processing units may include at least one second processing unit which performs a predetermined correction process on input image data.

According to a tenth aspect of the present invention, the image pickup device according to any one of the first to ninth aspects may include a plurality of image combining units, wherein the image combining units simultaneously generate and output respective third image data obtained by combining two pieces of input image data.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a schematic configuration of an image pickup device in accordance with a first preferred embodiment of the present invention;

FIGS. 2A, 2B, and 2C are diagrams each schematically illustrating an example of image capturing and display operations according to the image pickup device in accordance with the first preferred embodiment of the present invention;

FIG. 3 is a timing chart illustrating a schematic example of timings of the image capture and display operations according to the image pickup device in accordance with the first preferred embodiment of the present invention;

FIGS. 4A and 4B are diagrams each schematically illustrating an example of an added image generation operation by the image pickup device in accordance with the first preferred embodiment of the present invention;

FIG. 5 is a timing chart illustrating an example of a schematic timing of the added image generation operation according to the image pickup device in accordance with the first preferred embodiment of the present invention;

FIG. 6 is a diagram schematically illustrating an example of a relationship among image capture, image display, and recorded added image generation in the image pickup device in accordance with the first preferred embodiment of the present invention;

FIG. 7 is a diagram schematically illustrating an example of a relationship among image capture, image display, and recorded added image generation in a first modified example of the image pickup device of the first preferred embodiment of the present invention;

FIG. 8 is a diagram schematically illustrating an example of a relationship among image capture, image display, and recorded added image generation in a second modified example of the image pickup device of the first preferred embodiment of the present invention;

FIG. 9 is a diagram illustrating a relationship between an exposure time and a captured image in the image pickup device; and

FIG. 10 is a diagram schematically illustrating an example of an operation in which an image pickup device of the related art displays a cumulative added image while capturing an image.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

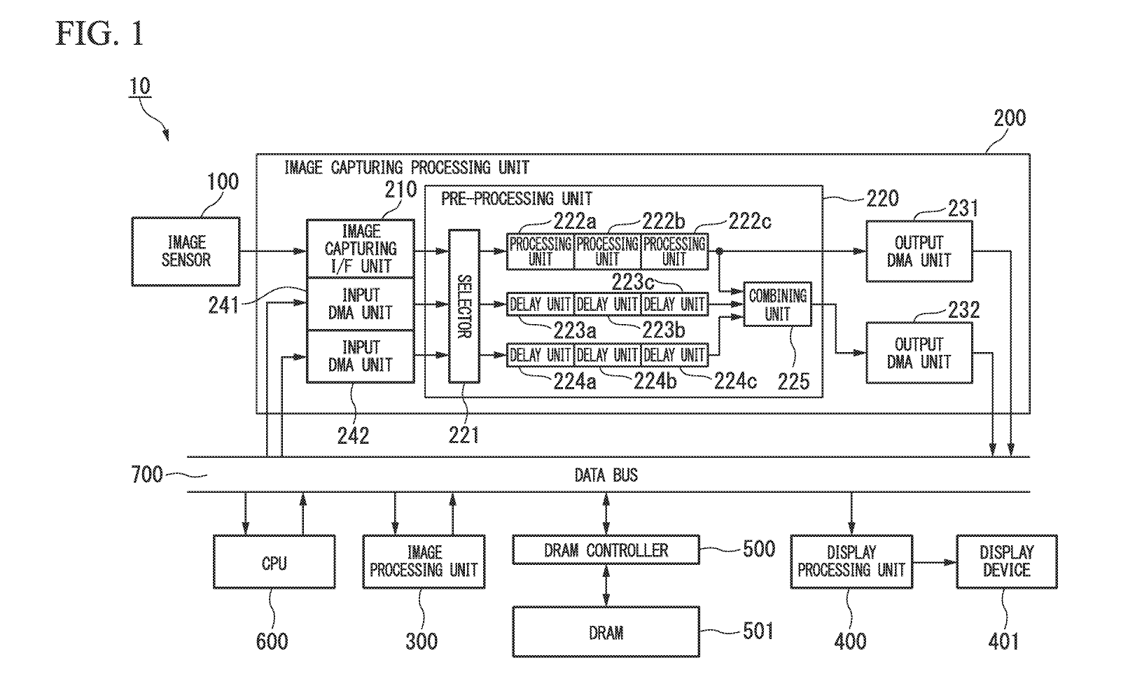

FIG. 1 is a block diagram illustrating a schematic configuration of an image pickup device in accordance with the first preferred embodiment of the present invention. The image pickup device 10 includes an image sensor 100, an image capturing processing unit 200, an image processing unit 300, a display processing unit 400, a display device 401, a dynamic random access memory (DRAM) controller 500, a DRAM 501, and a CPU 600.

The image capturing processing unit 200, the image processing unit 300, the display processing unit 400, the DRAM controller 500, and the CPU 600 are connected via a data bus 700. The image capturing processing unit 200, the image processing unit 300, the display processing unit 400, the DRAM controller 500, and the CPU 600, for example, read data from the DRAM 501 connected to the DRAM controller 500 through direct memory access (DMA) and write data to the DRAM 501.

The image pickup device 10 illustrated in FIG. 1 includes the same components as the image pickup device of the related art. However, in the image pickup device 10, the configuration of the image capturing processing unit 200 is different from the configuration of the image processing unit provided in the image pickup device of the related art. Because the image capturing processing unit 200 having a different configuration from the image pickup device of the related art is focused, the schematic configuration of the image capturing processing unit 200 is illustrated in FIG. 1.

The image capturing processing unit 200 includes an image capturing I/F unit 210, a pre-processing unit 220, two output DMA units 231 and 232, and two input DMA units 241 and 242.

The image sensor 100 is a charge coupled device (CCD) image sensor or a complementary metal-oxide semiconductor (CMOS) image sensor which photoelectrically converts an optical image of a subject formed by a lens (not illustrated) (also including a zoom lens).

For example, color filters of a Bayer array are attached to an image capturing plane of the image sensor 100. The image sensor 100 outputs image signals of colors (for example, R, Gr, Gb, and B) corresponding to subject light to the image capturing processing unit 200. Because the configuration and operation of the image sensor 100 are similar to the configuration and operation of the image sensor assumed to be provided in the image pickup device of the related art, detailed description thereof is omitted.

The image capturing processing unit 200 performs various processing on a pixel signal input from the image sensor 100. Then, the image capturing processing unit 200 stores image data (hereinafter referred to as a captured image) corresponding to the image signal input from the image sensor 100 in the DRAM 501 via the DRAM controller 500.

In addition, the image capturing processing unit 200 acquires (reads) a plurality of pieces of image data (captured images) stored in the DRAM 501 via the DRAM controller 500. The image capturing processing unit 200 generates image data of an added image (hereinafter referred to as a “recorded added image) to be recorded by the image pickup device 10 by adding (combining) acquired image data. Then, the image capturing processing unit 200 stores the generated recorded added image in the DRAM 501 via the DRAM controller 500.

In addition, the image capturing processing unit 200 adds (combines) image data (a captured image of a current frame) corresponding to a pixel signal input from the image sensor 100 and image data (a captured image of a previous frame) acquired (read) via the DRAM controller 500. Thereby, the image capturing processing unit 200 generates image data (a cumulative added image) of an added image to be displayed on the display device 401 in the image pickup device 10. Then, the image capturing processing unit 200 stores the generated cumulative added image in the DRAM 501 via the DRAM controller 500.

The image capturing I/F unit 210 obtains a pixel signal input from the image sensor 100 and outputs the obtained pixel signal as image data (a captured image of a current frame) to the pre-processing unit 220. When outputting the image data to the pre-processing unit 220, the image capturing I/F unit 210 performs a rearranging process of rearranging data of pixel signals of colors input from the image sensor 100 in order of colors of pixels to be used in a subsequent process or the like. In addition, when the image sensor 100 is an image sensor which outputs a pixel signal through a differential I/F, the image capturing I/F unit 210 also performs a termination process of low voltage differential signaling (LVDS) or the like. Also, because the configuration and operation of the image capturing I/F unit 210 are similar to the configuration and operation of the image capturing I/F unit assumed to be provided in the image pickup device of the related art, detailed description thereof is omitted.

The pre-processing unit 220 performs various pre-processing such as correction due to the image sensor 100 such as defect correction or shading correction and correction due to a lens such as distortion correction on image data input from the image capturing I/F unit 210. Then, the pre-processing unit 220 outputs image data of processing results (hereinafter referred to as “pre-processed image data”) to the output DMA unit 231.

In addition, the pre-processing unit 220 generates image data (hereinafter referred to as “delayed image data”) obtained by delaying image data input from one or both of the input DMA units 241 and 242 by a predetermined time. Then, the pre-processing unit 220 outputs image data (hereinafter referred to as “combined image data”) obtained by adding (combining) delayed image data or adding (combining) pre-processed image data and delayed image data to the output DMA unit 232.

As illustrated in FIG. 1, the pre-processing unit 220 includes a selector 221, three processing units 222a to 222c, three delay units 223a to 223c, three delay units 224a to 224c, and a combining unit 225.

The selector 221 selects output destinations of image data (a captured image of a current frame) input from the image capturing I/F unit 210 and image data (captured images of previous frames) input from the input DMA unit 241 and the input DMA unit 242. More specifically, the selector 221 outputs the image data input from the image capturing I/F unit 210 to one of the processing unit 222a, the delay unit 223a, and the delay unit 224a. In addition, the selector 221 outputs image data input from the input DMA unit 241 to one of the processing unit 222a, the delay unit 223a, and the delay unit 224a. In addition, the selector 221 outputs image data input from the input DMA unit 242 to one of the processing unit 222a, the delay unit 223a, and the delay unit 224a.

Each of the processing units 222a to 222c performs a predetermined process (correction process) on input image data. For example, the processing unit 222a performs a defect correction process on the input image data. In addition, for example, the processing unit 222b performs a shading correction process on image data after the defect correction process input from the processing unit 222a. In addition, for example, the processing unit 222c performs a distortion correction process on image data after the shading correction process input from the processing unit 222b.

Thereby, each of the processing units 222a to 222c sequentially performs a predetermined process (correction process) on input image data. Then, the processing unit 222c outputs image data after the process (correction process) as pre-processed image data to the output DMA unit 231. In addition, the pre-processed image data is also output to the combining unit 225. Also, because the configuration and operation of each of the processing units 222a to 222c are similar to the configuration and operation of the pre-processing unit assumed to be provided in the image pickup device of the related art, detailed description thereof is omitted.

Each of the delay units 223a to 223c corresponds to one of the processing units 222a to 222c. Each of the delay units 223a to 223c outputs input image data by delaying the input image data by the same time as a delay time from an input to an output in each of the processing units 222a to 222c. For example, the delay unit 223a outputs the input image data by delaying the input image data by the same time as the delay time (processing time) in which the input image data is delayed due to a defect correction process of the processing unit 222a. In addition, for example, the delay unit 223b outputs image data delayed by the delay unit 223a by delaying the image data by the same time as the delay time (processing time) in which the image data is delayed due to the shading correction process of the processing unit 222b. In addition, for example, the delay unit 223c outputs image data delayed by the delay unit 223b by delaying the image data by the same time as the delay time (processing time) in which the image data is delayed due to the distortion correction process of the processing unit 222c.

Each of the delay units 224a to 224c corresponds to one of the processing units 222a to 222c as in the delay units 223a to 223c. Each of the delay units 224a to 224c outputs the input image data by delaying the input image data by the same time as a delay time from an input to an output in one of the processing units 222a to 222c. That is, the delay unit 224a outputs the input image data by delaying the input image data by the same time as the delay time of the delay unit 223a. Likewise, the delay unit 224b outputs the input image data by delaying the input image data by the same time as the delay time of the delay unit 223b. The delay unit 224c outputs the input image data by delaying the input image data by the same time as the delay time of the delay unit 223c.

Thereby, each of the delay units 223a to 223c and the delay units 224a to 224c outputs the input image data by sequentially delaying the input image data by the same time as a delay time (processing time) of a corresponding processing unit. Then, image data delayed by the delay unit 223c and image data delayed by the delay unit 224c are output as respective delayed image data to the combining unit 225.

The combining unit 225 generates combined image data by combining input pre-processed image data and delayed image data. For example, the combining unit 225 generates the combined image data by combining the pre-processed image data input from the processing unit 222c and the delayed image data input from the delay unit 223c or the delay unit 224c. In addition, for example, the combining unit 225 generates combined image data by combining the delayed image data input from the delay unit 223c and the delayed image data input from the delay unit 224c. Also, the combining unit 225, for example, generates combined image data by performing a combining process such as an addition process, a subtraction process, a weighted addition process, or an averaging process on the pre-processed image data or the delayed image data for use in generation of combined image data. Then, the combining unit 225 outputs the generated combined image data to the output DMA unit 232.

The output DMA unit 231 stores pre-processed image data input from the processing unit 222c within the pre-processing unit 220 in the DRAM 501 via the DRAM controller 500 using DMA. Thereby, for example, pre-processed image data of a Bayer array corresponding to a pixel signal input from the image sensor 100 to the image capturing processing unit 200 is stored in the DRAM 501 as a captured image (Bayer data) to be processed by the image processing unit 300 or the display processing unit 400. Also, because the configuration and operation of the output DMA unit 231 are similar to the configuration and operation of the output DMA unit assumed to be provided in the image pickup device of the related art, detailed description thereof is omitted.

The output DMA unit 232 stores combined image data input from the combining unit 225 within the pre-processing unit 220 in the DRAM 501 via the DRAM controller 500 using DMA. The recorded added image or the cumulative added image (Bayer data) to be processed by the image processing unit 300 or the display processing unit 400 in order to perform a recording or display process according to the bulb photographing function of the image pickup device 10 is stored in the DRAM 501. Also, because the configuration and operation of the output DMA unit 232 are similar to the configuration and operation of the output DMA unit 231 except that image data to be stored in the DRAM 501 through DMA is different, detailed description thereof is omitted.

Each of the input DMA units 241 and 242 acquires (reads) image data (a captured image of a previous frame) stored in the DRAM 501 via the DRAM controller 500 using DMA. Then, each of the input DMA units 241 and 242 outputs the acquired image data to the pre-processing unit 220. Also, image data acquired by each of the input DMA units 241 and 242 may be not only image data stored by the output DMA unit 231 or 232, but also image data stored in the DRAM 501 after image processing has been performed by the image processing unit 300.

The image processing unit 300 acquires (reads) image data (a captured image or a recorded added image) stored in the DRAM 501. Then, the image processing unit 300 generates recording image data by performing various image processing such as noise cancellation, a YC conversion process, a resizing process, a JPEG compression process, and a moving-image compression process such as an MPEG compression process or an H.264 compression process on the acquired image data. Then, the image processing unit 300 stores (writes) the generated recording image data in the DRAM 501 again.

In addition, the image processing unit 300 acquires (reads) the recording image data stored in the DRAM 501 and generates image data on which various image processing such as moving image decompressing processes of a JPEG decompression process, an MPEG decompression process, an H.264 decompression process, etc. has been performed. Then, the image processing unit 300 stores (writes) the generated image data in the DRAM 501 again. Also, because the configuration and operation of the image processing unit 300 are similar to the configuration and operation of the image processing unit assumed to be provided in the image pickup device of the related art, detailed description thereof is omitted.

The display processing unit 400 acquires (reads) image data (a cumulative added image) stored in the DRAM 501. Then, the display processing unit 400 generates display image data (hereinafter referred to as a “display image”) by performing a display process such as display image processing of performing resizing (reducing) on a size of an image capable of being displayed by the display device 401 or a process of superimposing on-screen display (OSD) display data on the acquired image data. Then, the display processing unit 400 outputs the generated display image data (display image) on the display device 401 or an external display (not illustrated). Also, because the configuration and operation of the display processing unit 400 are similar to the configuration and operation of the display processing unit assumed to be provided in the image pickup device of the related art, detailed description thereof is omitted.

Also, the display processing unit 400 may be configured to perform only a display process such as a process of superimposing OSD display data. In this case, for example, the image processing unit 300 generates display image data (a display image) by performing display image processing on image data (a cumulative added image) or recording image data acquired (read) from the DRAM 501. Then, the image processing unit 300 stores (writes) the generated display image data in the DRAM 501 again. Then, the display processing unit 400 performs a display process such as a process of acquiring (reading) display image data stored in the DRAM 501 and superimposing OSD display data on the acquired display image data.

The display device 401 is a display device such as a thin film transistor (TFT) liquid crystal display (LCD) or an organic electro luminescence (EL) display device. The display device 401 displays an image corresponding to display image data (a display image) output from the display processing unit 400. Also, because the display device 401 is similar to the display device assumed to be provided in the image pickup device of the related art, detailed description thereof is omitted.

The DRAM controller 500 performs a process of storing (writing) data in the connected DRAM 501 and acquiring (reading) data from the DRAM 501 in response to a request for accessing the DRAM 501 from a plurality of components within the image pickup device 10 connected to the data bus 700, for example, a DMA access request. Also, because the configuration and operation of the DRAM controller 500 are similar to the configuration and operation of the DRAM controller assumed to be provided in the image pickup device of the related art, detailed description thereof is omitted.

The DRAM 501 is a memory whose access is controlled by the DRAM controller 500. The DRAM 501 stores various data in a processing process of each component within the image pickup device 10. Also, because the DRAM 501 is similar to the DRAM assumed to be provided in the image pickup device of the related art, detailed description thereof is omitted.

The CPU 600 controls components of the image pickup device 10, that is, the overall image pickup device 10. For example, the CPU 600 controls an operation of each component within the image pickup device 10 according to an image capturing operation or a reproduction operation in the image pickup device 10. For example, when the image pickup device 10 performs a photographing operation, the CPU 600 controls an output start of a pixel signal from the image sensor 100 and an acquisition start of a pixel signal by the image capturing I/F unit 210 within the image capturing processing unit 200.

In addition, the CPU 600 performs a process of setting or controlling the processing units 222a to 222c within the pre-processing unit 220, a process of setting the output DMA units 231 and 232, or a process of setting the input DMA units 241 and 242. In addition, the CPU 600 controls selection of image data by the selector 221 within the pre-processing unit 220 or selection of image data to be used for the combining unit 225 within the pre-processing unit 220 to generate combined image data.

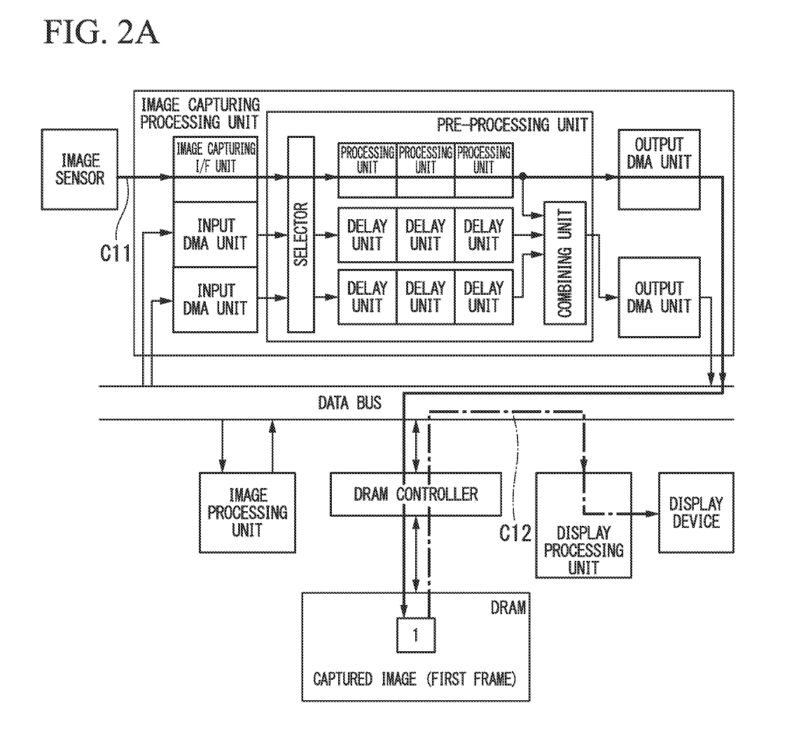

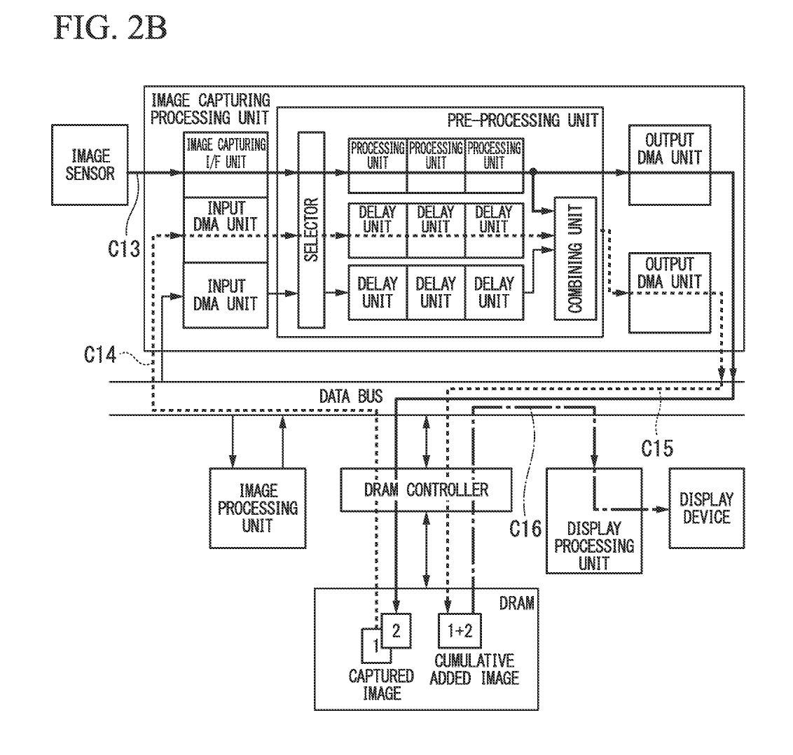

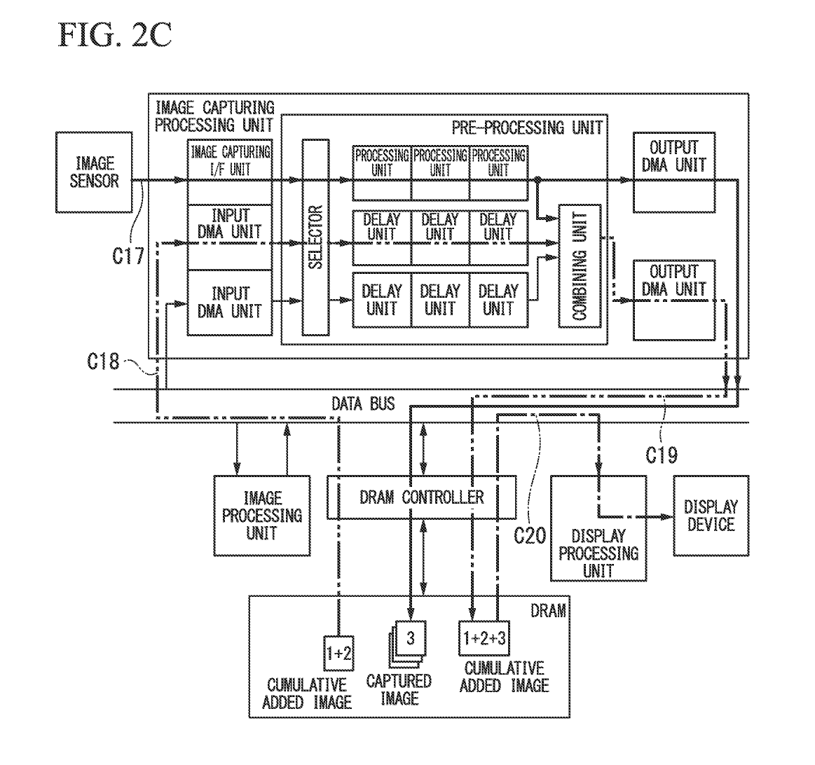

Next, an example of a photographing operation according to the bulb photographing function of the image pickup device 10 of the first preferred embodiment will be described. FIGS. 2A and 2B are diagrams each schematically illustrating an example of image capture and display operations according to the image pickup device 10 in accordance with the first preferred embodiment of the present invention. In photographing according to the bulb photographing function of the image pickup device 10, a cumulative added image obtained by sequentially adding (cumulatively adding) captured images is displayed on the display device 401 while captured images corresponding to pixel signals output from the image sensor 100 are stored in the DRAM 501. FIGS. 2A and 2B illustrate data paths in a captured image storage operation and cumulative added image generation and display operations on a block diagram of the image pickup device 10 illustrated in FIG. 1.

Hereinafter, processing procedures of the captured image storage operation and the cumulative added image generation and display operations in photographing according to the bulb photographing function of the image pickup device 10 will be sequentially described.

### (Procedure 1)

First, in the procedure 1, the CPU 600 controls the selector 221, for example, to select a path C11 illustrated in FIG. 2A as a data path. Then, the image capturing processing unit 200 stores pre-processed image data obtained by pre-processing image data corresponding to a pixel signal output from the image sensor 100 as a captured image (Bayer data) in the DRAM 501 via the DRAM controller 500.

More specifically, the pixel signal output from the image sensor 100 is input to the image capturing processing unit 200. The image capturing I/F unit 210 within the image capturing processing unit 200 outputs the input pixel signal as image data of a current frame to the pre-processing unit 220. Then, the selector 221 within the pre-processing unit 220 transfers the image data input from the image capturing I/F unit 210 to the processing unit 222a. Each of the processing units 222a to 222c sequentially performs pre-processing (a correction process) on the input image data. The pre-processing unit 220 outputs the pre-processed image data obtained by the processing unit 222c performing the pre-processing (the correction process) to the output DMA unit 231. Then, the output DMA unit 231 stores the pre-processed image data input from the pre-processing unit 220 as a captured image (Bayer data) of a first frame to the DRAM 501 via the DRAM controller 500.

Thereafter, the display processing unit 400 causes the display device 401 to display a display image corresponding to the captured image (Bayer data) of the first frame stored in the DRAM 501 on the display device 401. At this time, for example, data is input to the display processing unit 400 in a path C12 illustrated in FIG. 2A.

More specifically, the display processing unit 400 acquires (reads) the captured image of the first frame stored in the DRAM 501 via the DRAM controller 500. Then, the display processing unit 400 generates display image data (the display image) by performing a display process on the acquired captured image of the first frame. Then, the display processing unit 400 outputs the generated display image to the display device 401. Thereby, the display image (the captured image of the first frame) is displayed on the display device 401.

### (Procedure 2)

Subsequently, in the procedure 2, the CPU 600, for example, selects paths C13, C14, and C15 illustrated in FIG. 2B as data paths by controlling the selector 221 and the combining unit 225. Then, as in the procedure 1, the image capturing processing unit 200 stores pre-processed image data obtained by pre-processing image data corresponding to a pixel signal output from the image sensor 100 as a captured image (Bayer data) in the DRAM 501 via the DRAM controller 500.

More specifically, the pixel signal output from the image sensor 100 is input to the image capturing processing unit 200. The image capturing I/F unit 210 within the image capturing processing unit 200 outputs the input pixel signal as image data of a current frame to the pre-processing unit 220. Then, the selector 221 within the pre-processing unit 220 transfers image data input from the image capturing I/F unit 210 to the processing unit 222a. Each of the processing units 222a to 222c sequentially performs pre-processing (a correction process) on the input image data. The pre-processing unit 220 outputs the pre-processed image data obtained by the processing unit 222c performing the pre-processing (correction process) to the output DMA unit 231. The output DMA unit 231 stores the pre-processed image data input from the pre-processing unit 220 as a captured image (Bayer data) of a second frame in the DRAM 501 via the DRAM controller 500 (see the path C13). In addition, within the pre-processing unit 220, the pre-processed image data obtained by the processing unit 222c performing the pre-processing (correction process) is output to the combining unit 225.

In addition, likewise, the image capturing processing unit 200 acquires (reads) a captured image of a first frame stored in the DRAM 501. Then, the image capturing processing unit 200 stores combined image data obtained by combining the acquired captured image of the first frame with pre-processed image data (Bayer data) of a current frame (second frame) as a cumulative added image (Bayer data) in the DRAM 501 via the DRAM controller 500.

More specifically, the input DMA unit 241 within the image capturing processing unit 200 acquires (reads) the captured image of the first frame stored in the DRAM 501 via the DRAM controller 500. Then, the input DMA unit 241 outputs the acquired captured image of the first frame to the pre-processing unit 220. Then, the selector 221 within the pre-processing unit 220 transfers the captured image of the first frame input from the input DMA unit 241 to the delay unit 223a. Each of the delay units 223a to 223c delays the input captured image of the first frame by a predetermined time and outputs the delayed image to the combining unit 225 (see the path C14).

Then, the combining unit 225 generates combined image data by combining pre-processed image data obtained by the processing unit 222c performing the pre-processing (correction process), that is, a captured image of the second frame, with delayed image data obtained by the delay unit 223c performing a delay process, that is, the captured image of the first frame. Then, the pre-processing unit 220 outputs the combined image data generated by the combining unit 225 to the output DMA unit 232. Then, the output DMA unit 232 stores the combined image data input from the pre-processing unit 220 as a first cumulative added image (Bayer data) in the DRAM 501 via the DRAM controller 500 (see the path C15).

Thereafter, the display processing unit 400 causes the display device 401 to display a display image corresponding to a first cumulative added image (Bayer data) stored in the DRAM 501 on the display device 401. At this time, for example, data is input to the display processing unit 400 in the path C16 illustrated in FIG. 2B.

More specifically, the display processing unit 400 acquires (reads) the first cumulative added image stored in the DRAM 501 via the DRAM controller 500. Then, the display processing unit 400 generates display image data (a display image) by performing a display process on the acquired first cumulative added image. Then, the display processing unit 400 outputs the generated display image to the display device 401. Thereby, the display image (first cumulative added image) is displayed on the display device 401.

### (Procedure 3)

Subsequently, in the procedure 3, as in the procedure 2, the CPU 600, for example, selects paths C17, C18, and C19 illustrated in FIG. 2C as respective data paths by controlling the selector 221 and the combining unit 225. Then, as in the procedures 1 and 2, the image capturing processing unit 200 stores pre-processed data obtained by pre-processing image data corresponding to a pixel signal output from the image sensor 100 as a captured image (Bayer data) in the DRAM 501 via the DRAM controller 500.

More specifically, the pixel signal output from the image sensor 100 is input to the image capturing processing unit 200. Each of the processing units 222a to 222c sequentially performs pre-processing (the correction process) on image data of a current frame input from the image capturing I/F unit 210 within the image capturing processing unit 200. The DRAM 501 stores the pre-processed image data obtained by performing the pre-processing (correction process) as a captured image (Bayer data) of a third frame via the DRAM controller 500 (see the path C17). In addition, within the pre-processing unit 220, the pre-processed image data obtained by the processing unit 222c performing the pre-processing (correction process) is output to the combining unit 225.

In addition, simultaneously, the image capturing processing unit 200 acquires (reads) the first cumulative added image stored in the DRAM 501. Then, the image capturing processing unit 200 stores combined image data obtained by combining the acquired first cumulative added image with pre-processed image data (Bayer data) obtained by pre-processing a current frame (third frame) as a cumulative added image (Bayer data) in the DRAM 501 via the DRAM controller 500.

More specifically, the input DMA unit 241 within the image capturing processing unit 200 acquires (reads) the first cumulative added image stored in the DRAM 501 via the DRAM controller 500. Then, the input DMA unit 241 outputs the acquired first cumulative added image to the pre-processing unit 220. Then, the selector 221 within the pre-processing unit 220 transfers the first cumulative added image input from the input DMA unit 241 to the delay unit 223a. Each of the delay units 223a to 223c delays the input first cumulative added image by a predetermined time to output the delayed image to the combining unit 225 (see the path C18).

Then, the combining unit 225 generates combined image data by further combining delayed image data obtained by the delay unit 223c performing a delay process, that is, combined image data obtained by combining captured images of the first and second frames, with pre-processed image data obtained by the processing unit 222c performing pre-processing (a correction process), that is, a captured image of the third frame. Then, the pre-processing unit 220 outputs the combined image data generated by the combining unit 225 to the output DMA unit 232. Then, the output DMA unit 232 stores the combined image data input from the pre-processing unit 220 as a second cumulative added image (Bayer data) in the DRAM 501 via the DRAM controller 500 (see the path C19).

Thereafter, for example, in the path C20 illustrated in FIG. 2C, the display processing unit 400 causes the display device 401 to display the display image corresponding to the second cumulative added image (Bayer data) stored in the DRAM 501.

More specifically, the display processing unit 400 acquires (reads) the second cumulative added image stored in the DRAM 501. Then, the display processing unit 400 outputs display image data (a display image) generated by performing a display process to the display device 401. Thereby, the display image (second cumulative added image) is displayed on the display device 401.

Thereafter, the image capturing processing unit 200 iterates a process of storing a captured image (Bayer data) of a current frame in the DRAM 501 and a process of storing a cumulative added image (Bayer data) obtained by further combining the captured image of the current frame with a cumulative added image obtained by combining (cumulatively adding) captured images of previous frames in the DRAM 501 in the procedure 3. In addition, the display processing unit 400 iterates a process of generating a display image corresponding to a cumulative added image and outputting the generated display image to the display device 401 in the procedure 3.

In this manner, in the image pickup device 10, the CPU 600 controls the selector 221 and the combining unit 225 to select a path for processing image data as illustrated in FIGS. 2A, 2B, and 2C in each processing procedure. Thereby, in photographing using the bulb photographing function of the image pickup device 10, display images corresponding to cumulative added images obtained by sequentially adding (cumulatively adding) captured images are sequentially displayed on the display device 401 while a captured image corresponding to a pixel signal output from the image sensor 100 is stored in the DRAM 501. Thereby, the photographer can check an exposure level while photographing using the bulb photographing function of the image pickup device 10 and determine a timing at which the shutter is released.

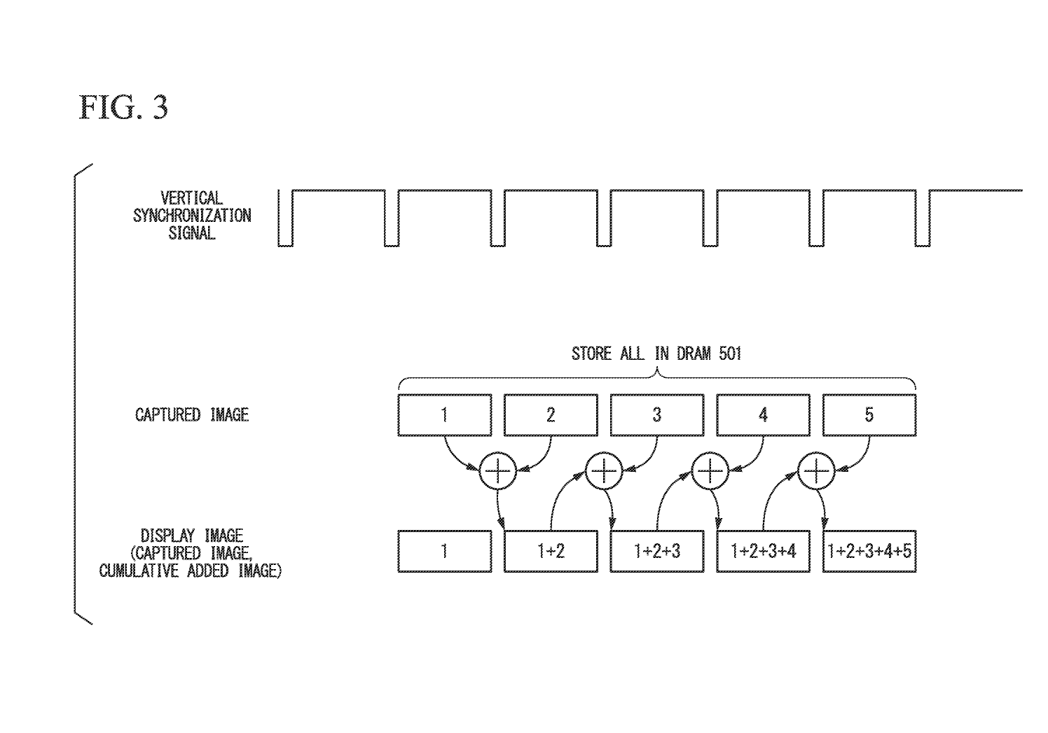

Here, a relationship between a captured image storage operation and an operation of generating and displaying a cumulative added image in the photographing using the bulb photographing function of the image pickup device 10 illustrated in FIGS. 2A, 2B, and 2C will be described. FIG. 3 is a timing chart illustrating a schematic example of timings of the image capture and display operations according to the image pickup device 10 in accordance with the first preferred embodiment of the present invention. FIG. 3 illustrates a relationship between timings of a captured image corresponding to a pixel signal output from the image sensor 100 and a display image displayed on the display device 401.

In FIG. 3, a “vertical synchronization signal” is a signal representing a timing at which the acquisition of a pixel signal output from the image sensor 100 is started. The display device 401 updates an image to be displayed every time a display image is input. Also, FIG. 3 illustrates the case in which the timing of the “vertical synchronization signal” is synchronized with a timing at which an image to be displayed by the display device 401 is updated to facilitate a comparison of a timing relationship between the captured image and the display image.

As illustrated in FIG. 3, the image capturing processing unit 200 provided in the image pickup device 10 stores all captured images corresponding to pixel signals output from the image sensor 100 in the DRAM 501 (see the procedures 1 to 3). In addition, the image capturing processing unit 200 generates combined image data obtained by the combining unit 225 adding (combining) a captured image of a current frame corresponding to a pixel signal output from the image sensor 100 and a captured image of a previous frame stored in the DRAM 501 or a cumulative added image obtained by cumulatively adding captured images of previous frames (see the procedures 2 and 3). Thereafter, the display processing unit 400 provided in the image pickup device 10 displays the captured image or the cumulative added image stored in the DRAM 501 as a display image on the display device 401 (see the procedures 1 to 3).

In this manner, in the image pickup device 10, all captured images corresponding to pixel signals output from the image sensor 100 are stored in the DRAM 501. Thereby, in the image pickup device 10, the photographer can generate an image (recorded added image) of a desired exposure level after photographing according to the bulb photographing function has ended.

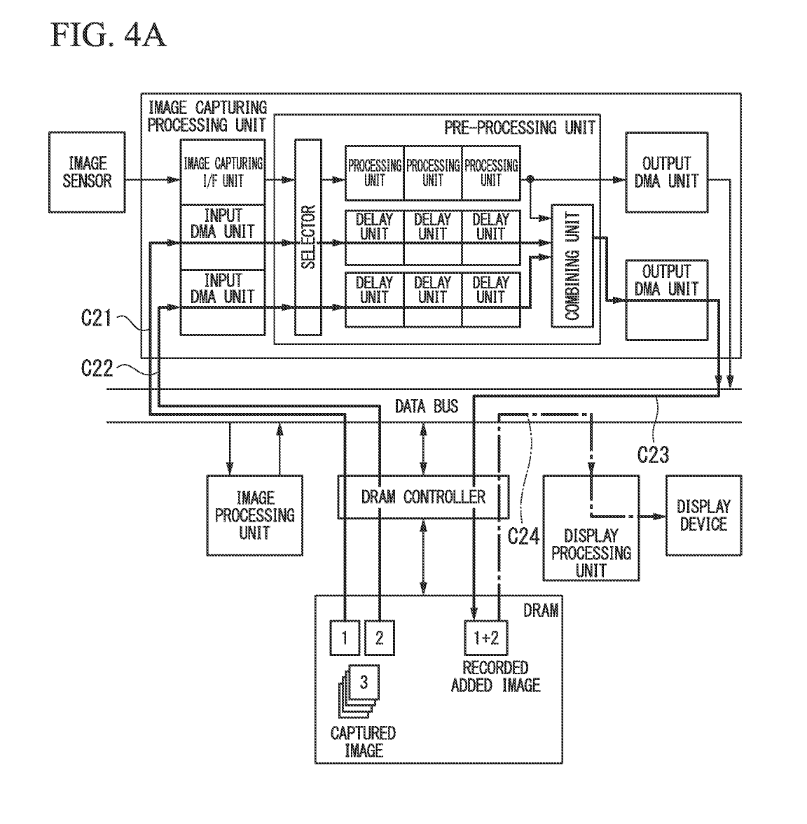

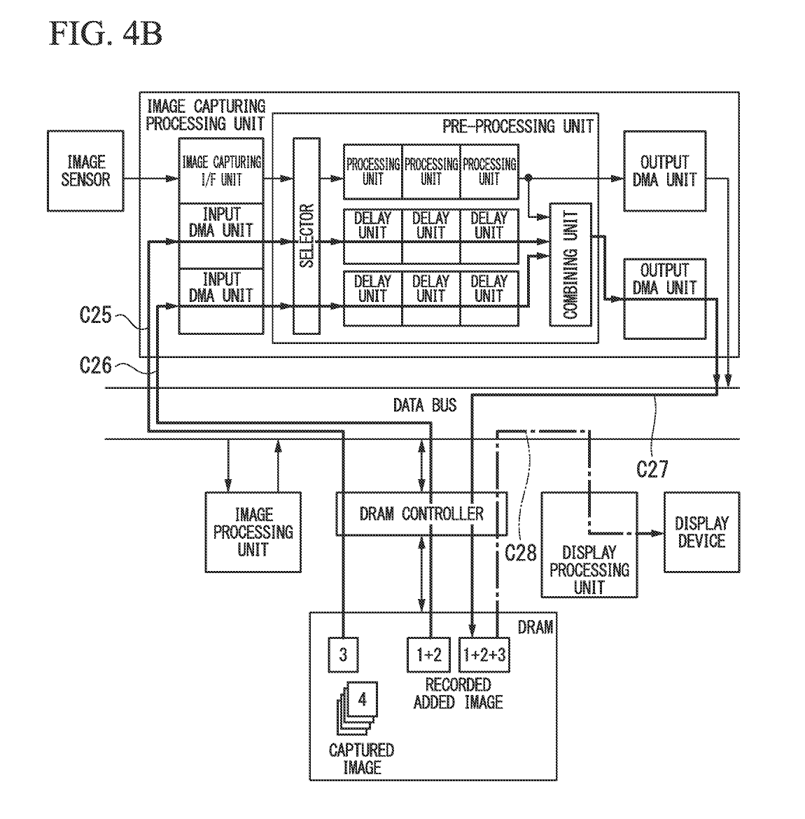

Next, an example of an operation of generating a recorded added image according to the bulb photographing function of the image pickup device 10 of the first preferred embodiment will be described. FIGS. 4A and 4B are diagrams each schematically illustrating an example of an added image generation operation by the image pickup device 10 in accordance with the first preferred embodiment of the present invention. In the operation of generating a recorded added image according to the bulb photographing function of the image pickup device 10, the recorded added image is generated by adding captured images stored in the DRAM 501. In addition, the generated recorded added image is displayed on the display device 401. FIGS. 4A and 413 illustrate data paths in the operation of generating and displaying the recorded added image on the block diagram of the image pickup device 10 illustrated in FIG. 1.

Hereinafter, processing procedures of the operation of generating and displaying the recorded added image according to the bulb photographing function of the image pickup device 10 will be sequentially described.

### (Procedure 1)

First, in the procedure 1, the CPU 600 controls the selector 221 and the combining unit 225, for example, to select paths C21, C22, and C23 illustrated in FIG. 4A as respective data paths. Then, the image capturing processing unit 200 acquires (reads) a captured image (Bayer data) of a first frame and a captured image (Bayer data) of a second frame stored in the DRAM 501. Then, the image capturing processing unit 200 stores combined image data obtained by combining the acquired captured images of the first and second frames as a recorded added image (Bayer data) in the DRAM 501 via the DRAM controller 500.

More specifically, the input DMA unit 241 within the image capturing processing unit 200 acquires (reads) the captured image of the first frame stored in the DRAM 501 via the DRAM controller 500 and outputs the acquired captured image of the first frame to the pre-processing unit 220. Then, the selector 221 within the pre-processing unit 220 transfers the captured image of the first frame input from the input DMA unit 241 to the delay unit 223a. Each of the delay units 223a to 223c delays the input captured image of the first frame by a predetermined time and outputs the delayed image to the combining unit 225 (see the path C21).

The input DMA unit 242 within the image capturing processing unit 200 acquires (reads) the captured image of the second frame stored in the DRAM 501 via the DRAM controller 500 and outputs the acquired captured image of the second frame to the pre-processing unit 220. Then, the selector 221 within the pre-processing unit 220 transfers the captured image of the second frame input from the input DMA unit 242 to the delay unit 224a. Each of the delay units 224a to 224c delays the input captured image of the second frame by a predetermined time and outputs the delayed image to the combining unit 225 (see the path C22).

Then, the combining unit 225 generates combined image data by combining delayed image data obtained by the delay unit 223c performing a delay process, that is, the captured image of the first frame, with delayed image data obtained by the delay unit 224c performing a delay process, that is, the captured image of the second frame. Then, the pre-processing unit 220 outputs the combined image data generated by the combining unit 225 to the output DMA unit 232. Then, the output DMA unit 232 stores the combined image data input from the pre-processing unit 220 as a first recorded added image (Bayer data) in the DRAM 501 via the DRAM controller 500 (see the path C23).

Thereafter, the display processing unit 400 causes the display device 401 to display a display image corresponding to the first recorded added image (Bayer data) stored in the DRAM 501 on the display device 401. At this time, for example, data is input to the display processing unit 400 in the path C24 illustrated in FIG. 4A.

More specifically, the display processing unit 400 acquires (reads) the first recorded added image stored in the DRAM 501 via the DRAM controller 500. Then, the display processing unit 400 generates display image data (a display image) by performing a display process on the acquired first recorded added image. Then, the display processing unit 400 outputs the generated display image to the display device 401. Thereby, the display image (first recorded added image) is displayed on the display device 401.

### (Procedure 2)

Subsequently, in the procedure 2, the CPU 600 controls the selector 221 and the combining unit 225, for example, to select paths C25, C26, and C27 illustrated in FIG. 4B as respective data paths. Then, as in the procedure 1, the image capturing processing unit 200 acquires (reads) a first recorded added image (Bayer data) and a captured image (Bayer data) of a third frame stored in the DRAM 501. Then, the image capturing processing unit 200 stores combined image data obtained by combining the acquired first recorded added image with the captured image of the third frame as a recorded added image (Bayer data) in the DRAM 501 via the DRAM controller 500.

More specifically, the input DMA unit 241 within the image capturing processing unit 200 acquires (reads) the captured image of the third frame stored in the DRAM 501 via the DRAM controller 500 and outputs the acquired captured image of the third frame to the pre-processing unit 220. Then, the selector 221 within the pre-processing unit 220 transfers the captured image of the third frame input from the input DMA unit 241 to the delay unit 223a. Each of the delay units 223a to 223c delays the input captured image of the third frame by a predetermined time and outputs the delayed image to the combining unit 225 (see the path C25).

In addition, the input DMA unit 242 within the image capturing processing unit 200 acquires (reads) the first recorded added image stored in the DRAM 501 via the DRAM controller 500 and outputs the acquired first recorded added image to the pre-processing unit 220. Then, the selector 221 within the pre-processing unit 220 transfers the first recorded added image input from the input DMA unit 242 to the delay unit 224a. Each of the delay units 224a to 224c delays the input first recorded added image by a predetermined time and outputs the delayed image to the combining unit 225 (see the path C26).

Then, the combining unit 225 generates combined image data by combining delayed image data obtained by the delay unit 223c performing a delay process, that is, the captured image of the third frame, with delayed image data obtained by the delay unit 224c performing a delay process, that is, the first recorded added image obtained by combining captured images of first and second frames. Then, the pre-processing unit 220 outputs the combined image data generated by the combining unit 225 to the output DMA unit 232. Then, the output DMA unit 232 stores the combined image data input from the pre-processing unit 220 as a second recorded added image (Bayer data) in the DRAM 501 via the DRAM controller 500 (see the path C27).

Thereafter, the display processing unit 400 causes the display device 401 to display a display image corresponding to the second recorded added image (Bayer data) stored in the DRAM 501 on the display device 401, for example, in the path C28 illustrated in FIG. 4B.

More specifically, the display processing unit 400 acquires (reads) the second recorded added image stored in the DRAM 501 and outputs display image data (a display image) generated by performing a display process to the display device 401. Thereby, the display image (second recorded added image) is displayed on the display device 401.

Thereafter, the image capturing processing unit 200 iterates a process of storing a recorded added image (Bayer data) obtained by further combining the recorded added image obtained by combining (cumulatively adding) captured images of previous frames with a captured image of the next frame in the DRAM 501 in the procedure 2. In addition, the display processing unit 400 iterates a process of generating a display image corresponding to the recorded added image and outputting the generated display image to the display device 401 in the procedure 2.

In this manner, in the image pickup device 10, the CPU 600 controls the selector 221 and the combining unit 225 to select a path for processing image data as illustrated in FIGS. 4A and 4B in each processing procedure. Thereby, in a process of generating a recorded added image according to the bulb photographing function of the image pickup device 10, the generated recorded added image is displayed on the display device 401 while the recorded added image is generated by adding captured images stored by photographing according to the bulb photographing function of the image pickup device 10. Thereby, the photographer can check an exposure level of an image (recorded added image) to be recorded and determine an image of a desired exposure level as an image to be ultimately recorded.

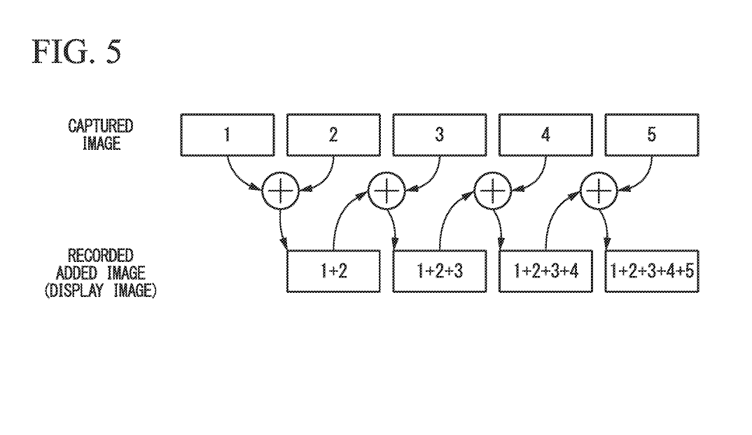

Here, a timing relationship in an example of an operation of generating and displaying a recorded added image according to the bulb photographing function of the image pickup device 10 illustrated in FIGS. 4A and 413 will be described. FIG. 5 is a timing chart illustrating an example of a schematic timing of the added image generation operation according to the image pickup device 10 in accordance with the first preferred embodiment of the present invention. In FIG. 5, a relationship between timings of a captured image stored in the DRAM 501 and a generated recorded added image, which is a display image to be displayed on the display device 401, is illustrated.

As illustrated in FIG. 5, the image capturing processing unit 200 provided in the image pickup device 10 sequentially generates combined image data obtained by the combining unit 225 sequentially adding (combining) a captured image of a first frame stored in the DRAM 501 to a captured image of a subsequent frame as the recorded added image (see the procedures 1 and 2). Here, the display processing unit 400 provided in the image pickup device 10 reads each generated recorded added image from the DRAM 501 and causes the display device 401 to display the read image as a display image (see the procedures 1 and 2).

Also, as can be seen from FIG. 5, in a process in which the image capturing processing unit 200 generates a recorded added image, for example, there is no timing at which a cycle used to generate the recorded added image is determined as in the “vertical synchronization signal” at a timing of photographing according to the bulb photographing function of the image pickup device 10 illustrated in FIG. 3. However, considering that the image capturing processing unit 200 causes the display device 401 to display the generated recorded added image, it may be desirable for the image capturing processing unit 200 to generate the recorded added image, for example, at a timing of the vertical synchronization signal of the display device 401, in order to update an image displayed by the display device 401.

In this manner, because all captured images corresponding to pixel signals output from the image sensor 100 are stored in the DRAM 501 using the photographing according to the bulb photographing function in the image pickup device 10, the photographer can generate an image (recorded added image) of a desired exposure level after the photographing according to the bulb photographing function has ended. Thereby, even when the shutter timing in the photographing according to the bulb photographing function is deviated from an intended exposure point, the photographer can obtain an image of a desired exposure level without performing the photographing of the bulb photographing function again.

Also, it is possible to generate the recorded added image at any timing after the photographing according to the bulb photographing function has ended. In addition, it is possible to generate a plurality of recorded added images from one photographing process according to the bulb photographing function or edit a generated recorded added image, that is, re-generate a different recorded added image.

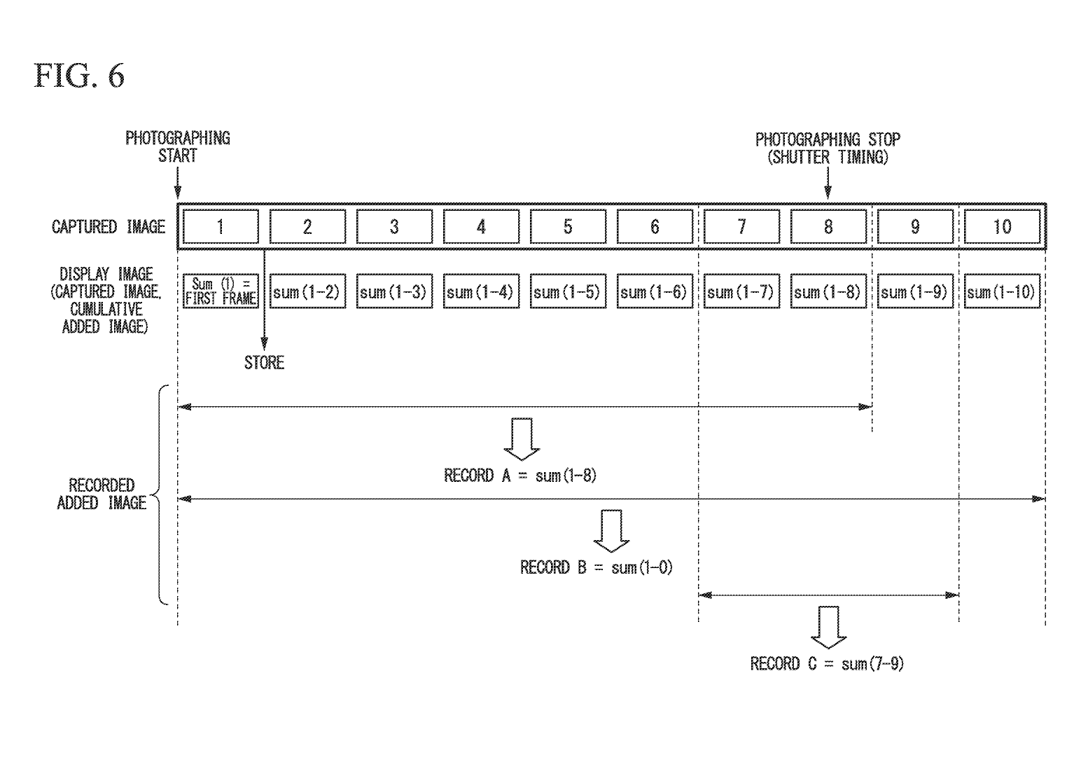

Here, the recorded added image obtained by the bulb photographing function of the image pickup device 10 will be described. FIG. 6 is a diagram schematically illustrating an example of a relationship among image capture, image display, and recorded added image generation in the image pickup device 10 in accordance with the first preferred embodiment of the present invention.

If the photographer issues an instruction to start photographing according to the bulb photographing function, the image pickup device 10 starts the photographing and sequentially stores captured images corresponding to pixel signals output from the image sensor 100 in the DRAM 501 as illustrated in FIG. 6. At this time, the combining unit 225 within the image capturing processing unit 200 generates cumulative added images obtained by sequentially adding (cumulatively adding) respective captured images and the display processing unit 400 causes the display device 401 to sequentially display the cumulative added images. In FIG. 6, the case in which a photographing stop instruction representing a shutter timing intended by the photographer is issued when the image pickup device 10 has captured a captured image of an eighth frame and captured images up to a tenth frame have been stored in the DRAM 501 is illustrated.

Thereafter, the image pickup device 10 generates a recorded added image using some or all of captured images stored in the DRAM 501 according to an instruction of the photographer. As described above, in the image pickup device 10, all captured images corresponding to pixel signals output from the image sensor 100 are stored in the DRAM 501. Thus, as illustrated in FIG. 6, it is possible to generate a recorded added image obtained by adding (combining) various captured images.

In FIG. 6, an example in which a recorded added image obtained by adding (combining) captured images (Bayer data) of first to eighth frames, that is, captured images from a capture start to a shutter timing, has been generated as the recorded added image A is illustrated. In addition, in FIG. 6, an example in which a recorded added image obtained by adding (combining) captured images (Bayer data) of first to tenth frames, that is, all captured images stored in the DRAM 501, has been generated as the recorded added image B is illustrated. In addition, in the image pickup device 10, as illustrated in FIG. 6, it is possible to generate a recorded added image C by adding (combining) captured images (Bayer data) of seventh to ninth frames, that is, by adding (combining) a captured image of the shutter timing and captured images, each of which corresponds to one frame, before and after the captured image of the shutter timing.

As described above, in the image pickup device 10 in the first preferred embodiment, display images corresponding to cumulative added images obtained by sequentially adding (cumulatively adding) pixel signals output from the image sensor 100 in the photographing according to the bulb photographing function are sequentially displayed on the display device 401. Thereby, the photographer can check an exposure level while photographing using the bulb photographing function of the image pickup device 10 and determine a timing at which the shutter is released.

In addition, in the image pickup device 10 in the first preferred embodiment, a captured image corresponding to a pixel signal output from the image sensor 100 as well as a cumulative added image obtained at a timing at which the shutter has been released in the photographing according to the bulb photographing function are both stored in the DRAM 501. Then, in the image pickup device 10 in the first preferred embodiment, a recorded added image is generated by adding (combining) captured images stored in the DRAM 501 after the photographing according to the bulb photographing function has ended, and a display image corresponding to the generated recorded added image is displayed on the display device 401. Thereby, the photographer can easily check an exposure level of the recorded added image and determine a recorded added image of a desired exposure level as an image to be ultimately recorded. Even when a timing at which the shutter is released in the photographing according to the bulb photographing function is deviated from an intended timing, the photographer can obtain an image of a desired exposure level without performing the photographing of the bulb photographing function again.

Also, in the image pickup device 10 in the first preferred embodiment, as described above, captured images corresponding to pixel signals output from the image sensor 100 are all stored in the DRAM 501. Thus, when the exposure time of the photographing according to the bulb photographing function is lengthened, the storage capacity of the DRAM 501 capable of storing captured images corresponding to the lengthened exposure time is necessary. However, the storage capacity of the DRAM 501 provided in the image pickup device 10 is finite and a process of storing all captured images corresponding to pixel signals output from the image sensor 100 in the DRAM 501 is not realistic. Therefore, the following modified examples of the image pickup device 10 are considered to reduce the storage capacity of the DRAM 501 required to be provided in the image pickup device 10 in order to store a captured image.

### First Modified Example

In the first modified example, a captured image of a shutter timing at which a photographing stop instruction has been issued and captured images of a predetermined number of frames before and after the captured image of the shutter timing are stored in the DRAM 501. That is, in the first modified example, captured images of a predetermined number of frames before the shutter timing from the capturing start are not stored in the DRAM 501. This is because captured images useful in adjusting the exposure level during photographing according to the bulb photographing function are captured images of several frames before and after a timing at which the shutter has been released. In addition, this is because a captured image captured at a time separate from the shutter timing is less likely to be used by the photographer to adjust a desired exposure level in a recorded added image to be generated thereafter. In particular, because an exposure amount of captured images immediately after the photographing has been started is significantly low in a bulb photographing process of performing photography in darkness, this trend is said to be remarkable. In addition, in the first modified example, the cumulative added image is stored in the DRAM 501 in a period in which no captured image is stored in the DRAM 501, so that captured images of the period are supplemented.

Thereby, in the first modified example, it is possible to reduce the storage capacity of the DRAM 501 corresponding to ((Number of captured images in a period in which no storage is performed in the DRAM 501)−1). In addition, in the first modified example, it is only necessary to store captured images and a cumulative added image for a given number of frames in the DRAM 501. That is, in a method of storing the captured images according to the first modified example, it is only necessary to store only captured images for a number of frames equal to ((Given number of frames×2)+1 frame) and a cumulative added image for one frame in the DRAM 501. Thus, in the first modified example, it is only necessary to provide the DRAM 501 of a given storage capacity in the image pickup device 10 regardless of the exposure time during photography according to the bulb photographing function. Therefore, the image pickup device 10 can be easily implemented.

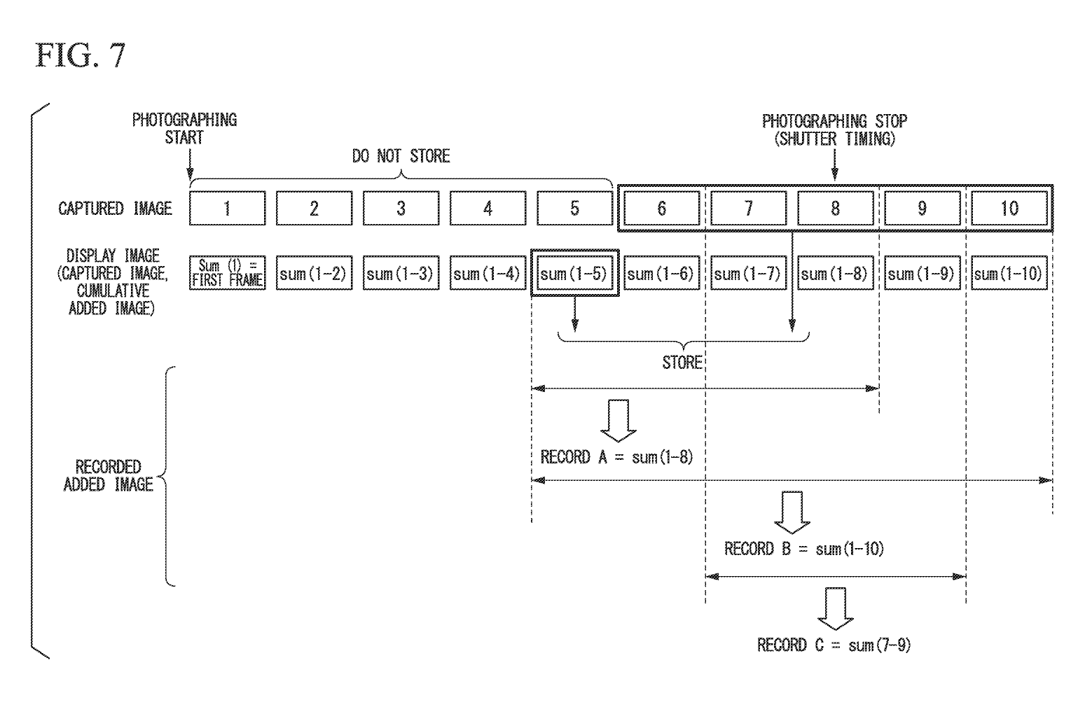

FIG. 7 is a diagram schematically illustrating an example of a relationship among image capture, image display, and recorded added image generation in the first modified example of the image pickup device 10 of the first preferred embodiment. In FIG. 7, the case in which the photographing stop instruction has been issued by the photographer using the timing at which the image pickup device 10 has captured a captured image of an eighth frame as the shutter timing when the captured image of the shutter timing and the captured images of two frames before and after the captured image of the shutter timing are stored in the DRAM 501 is illustrated. Accordingly, as illustrated in FIG. 7, the image pickup device 10 stores image data of six frames including captured images of sixth to tenth frames and a cumulative added image (sum (1−5)) obtained by sequentially adding (cumulatively adding) captured images (Bayer data) of first to fifth frames in the DRAM 501.

Also, as a method of storing the captured image of the shutter timing and the captured images for two frames before and after the captured image of the shutter timing in the DRAM 501, a method of storing captured images of a given number of frames and a cumulative added image in the DRAM 501 may be used. For example, a method of reducing a first stored captured image (that is, a captured image of a first frame) from the DRAM 501 after a captured image of the next frame has been stored after being captured images corresponding to pixel signals output from the image sensor 100 have been sequentially stored in the DRAM 501 and the number of frames of captured images stored in the DRAM 501 has reached the given number of frames is possible. In addition, for example, a method in which a captured image of the next frame is stored (that is, overwritten) in a region of the DRAM 501 in which a captured image of a first frame is stored after a given number of frames of captured images stored in the DRAM 501 have been stored is also possible.

Thereafter, the image pickup device 10 generates a recorded added image using a captured image or a cumulative added image stored in the DRAM 501 according to an instruction of the photographer. Thereby, as in the example illustrated in FIG. 6, the image pickup device 10 can generate a recorded added image by adding (combining) various captured images. That is, as in the case in which all captured images corresponding to pixel signals output from the image sensor 100 are stored in the DRAM 501, recorded added images such as recorded added images A, B, and C can be generated.

Here, a method of generating the recorded added image in the first modified example will be described. In the image capturing processing unit 200, the recorded added image A obtained by adding (combining) captured images (Bayer data) of first to eighth frames, that is, captured images from the image capturing start to the shutter timing, is generated by sequentially adding (combining) captured images of sixth to eighth frames to a cumulative added image (sum (1−5)) stored in the DRAM 501.

In addition, in the image capturing processing unit 200, the recorded added image B obtained by adding (combining) captured images (Bayer data) of first to tenth frames, that is, all captured images corresponding to pixel signals output from the image sensor 100, is generated by sequentially adding (combining) the captured images of the sixth to tenth frames to the cumulative added image (sum (1−5)) stored in the DRAM 501.

In addition, in the image capturing processing unit 200, the recorded added image C obtained by adding (combining) the captured images (Bayer data) of the seventh to ninth frames, that is, by adding (combining) a captured image of the shutter timing and captured images, each of which corresponds to one frame, before and after the captured image of the shutter timing, is generated by sequentially adding (combining) the captured images of the seventh to ninth frames stored in the DRAM 501 as in the example illustrated in FIG. 6.

In this manner, the photographer can also obtain an image (recorded added image) of a desired exposure level in the first modified example in the image pickup device 10. In addition, in the method of the first modified example, not all captured images corresponding to pixel signals output from the image sensor 100 are stored in the DRAM 501. Practically, only captured images of a useful number of frames and a cumulative added image are stored in the DRAM 501. Thereby, in the first modified example, it is possible to reduce the storage capacity of the DRAM 501 required to be provided in the image pickup device 10 in which captured images and a cumulative added image are stored.

### Second Modified Example

In the second modified example, a cumulative added image of a shutter timing for which a photographing stop instruction has been issued and a predetermined number of cumulative added images before and after the cumulative added image of the shutter timing are stored in the DRAM 501. That is, in the second modified example, not all captured images corresponding to pixel signals output from the image sensor 100 are stored in the DRAM 501. Only a predetermined number of cumulative added images before and after the shutter timing are stored in the DRAM 501. This is similar to a corresponding concept in the first modified example.

Thereby, in the second modified example, it is possible to reduce the storage capacity of the DRAM 501 corresponding to the number of captured images in a period in which no storage is performed in the DRAM 501. In addition, in the second modified example, as in the first modified example, it is also only necessary to provide the DRAM 501 of a given storage capacity in the image pickup device 10 so that a given number of cumulative added images are stored regardless of an exposure time of photographing according to the bulb photographing function. Therefore, it is possible to easily implement the image pickup device 10. That is, in a method of storing a captured image according to the second modified example, it is only necessary to store ((Predetermined number×2)+1) cumulative added images in the DRAM 501.

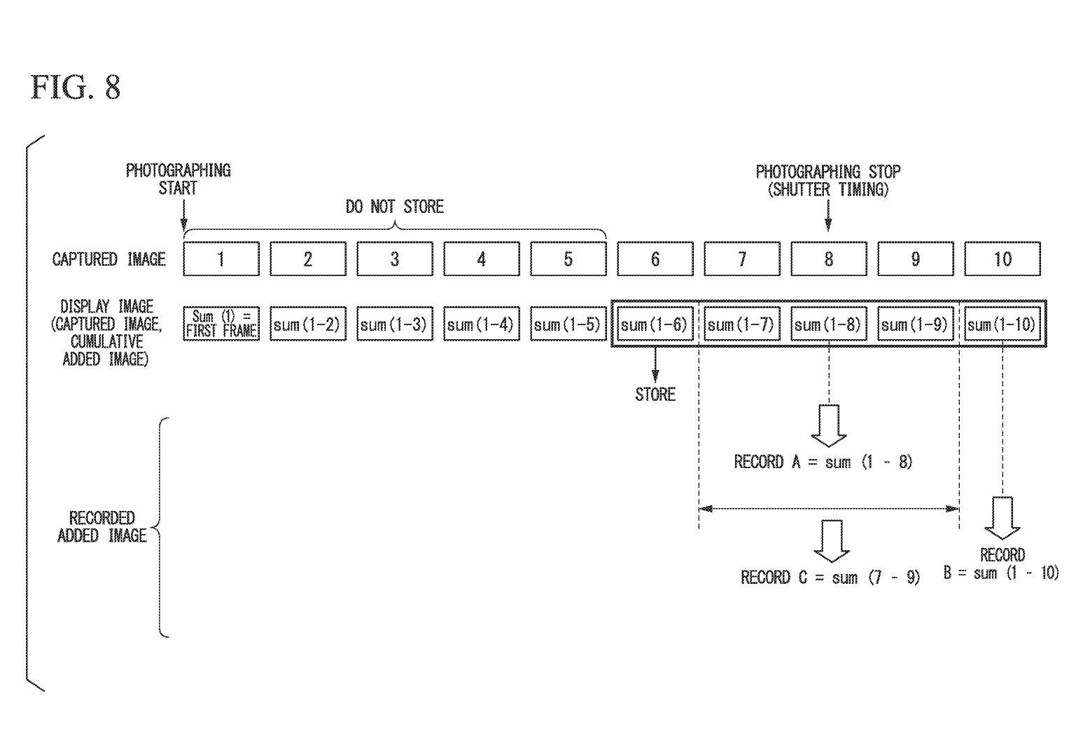

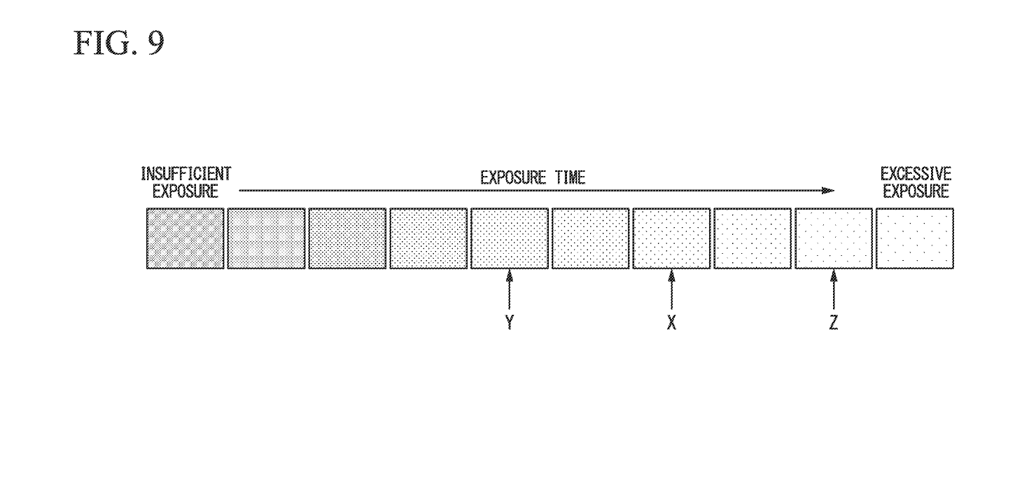

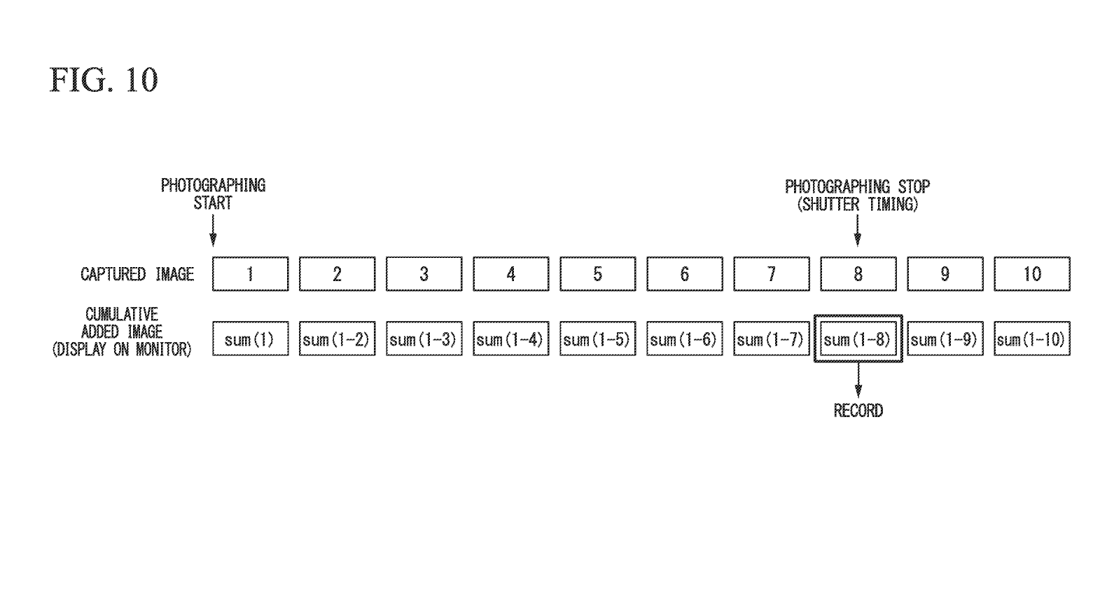

FIG. 8 is a diagram schematically illustrating an example of a relationship among image capture, image display, and recorded added image generation in the second modified example of the image pickup device 10 of the first preferred embodiment. In FIG. 8, the case in which the photographing stop instruction has been issued by the photographer using the timing at which the image pickup device 10 has captured a captured image of an eighth frame as the shutter timing when a cumulative added image of the shutter timing and two cumulative added images before and after the cumulative added image of the shutter timing are stored in the DRAM 501 is illustrated. Accordingly, as illustrated in FIG. 8, the image pickup device 10 stores five cumulative added images subsequent to a cumulative added image (sum (1−6)) in the DRAM 501 by sequentially adding (cumulatively adding) sixth to tenth cumulative added images (Bayer data), that is, captured images (Bayer data) of the first to sixth frames.

Also, as a method of storing a cumulative added image of the shutter timing and a predetermined number of cumulative added images before and after the cumulative added image of the shutter timing in the DRAM 501, a process of storing a given number of cumulative added images may be used as in the concept in the first modified example.

Thereafter, the image pickup device 10 generates a recorded added image using a cumulative added image stored in the DRAM 501 according to an instruction of the photographer, so that the image pickup device 10 can generate a recorded added image by adding (combining) various captured images as in the example illustrated in FIG. 6. That is, as in the case in which all captured images corresponding to pixel signals output from the image sensor 100 are stored in the DRAM 501, recorded added images such as recorded added images A, B, and C can be generated.

Here, a method of generating a recorded added image in the second modified example will be described. In the second modified example, because the cumulative added image is stored in the DRAM 501, the recorded added image A obtained by adding (combining) captured images (Bayer data) of captured images of first to eighth frames, that is, captured images from a photographing start to the shutter timing, is an eighth cumulative added image (sum (1−8)) stored in the DRAM 501. Accordingly, the image capturing processing unit 200 can directly set a cumulative added image (sum 1−8)) stored in the DRAM 501 as the recorded added image A without performing an addition (combination) process on the cumulative added image stored in the DRAM 501.

Likewise, the recorded added image B obtained by adding (combining) captured images (Bayer data) of first to tenth frames, that is, all captured images corresponding to pixel signals output from the image sensor 100, is also a tenth cumulative added image (sum (1−10)) stored in the DRAM 501, and the cumulative added image (sum (1−10)) stored in the DRAM 501 can be set as the recorded added image B.

In addition, the recorded added image C obtained by adding (combining) the captured images (Bayer data) of the seventh to ninth frames, that is, by adding (combining) a captured image of the shutter timing and captured images, each of which corresponds to one frame, before and after the captured image of the shutter timing, can also be generated based on a cumulative added image stored in the DRAM 501. However, the recorded added image C is generated by performing a subtraction process without performing an addition process in the combining unit 225 provided in the image capturing processing unit 200. More specifically, the recorded added image C is generated by performing a process of subtracting a sixth cumulative added image (sum (1−6)) stored in the DRAM 501 from a ninth cumulative added image (sum (1−9)) stored in the DRAM 501. Also, a subtraction process between cumulative added images, for example, may be configured to be performed by the image processing unit 300 provided in the image pickup device 10 in place of the combining unit 225.

In this manner, the photographer can also obtain an image (recorded added image) of a desired exposure level in the method of the second modified example in the image pickup device 10. In addition, in the method of the second modified example, not all captured images corresponding to pixel signals output from the image sensor 100 are stored in the DRAM 501. Practically, only a useful number of cumulative added images are stored in the DRAM 501. Thereby, in the second modified example, it is possible to further reduce the storage capacity of the DRAM 501 required to be provided in the image pickup device 10 in which captured images and a cumulative added image are stored than in the first modified example.

In addition, in the second modified example, the image capturing processing unit 200 can directly set a cumulative added image stored in the DRAM 501 as a recorded added image without performing an addition (combination) process on the cumulative added image stored in the DRAM 501. Thereby, in the second modified example, it is possible to shorten a time until a display image corresponding to a recorded added image (Bayer data) is displayed on the display device 401. Thereby, the photographer can quickly check an exposure level of an image (recorded added image) to be recorded.

As described above, in a mode for carrying out the present invention, an input DMA unit (the input DMA units 241 and 242 in the first preferred embodiment) which acquires (reads) image data stored in the DRAM is provided within the image capturing processing unit of the image pickup device. In addition, within the pre-processing unit provided in the image capturing processing unit (the pre-processing unit 220 in the first preferred embodiment), the combining unit (the combining unit 225 in the first preferred embodiment) which generates combined image data by combining image data of a current frame and image data of a previous frame or by combining image data stored in the DRAM is provided. In addition, within the image capturing processing unit of the image pickup device, the output DMA unit (the output DMA unit 232 in the first preferred embodiment) which stores combined image data generated by the combining unit in the DRAM is provided.

Thereby, according to the mode for carrying out the present invention, it is possible to implement an image pickup device which generates a cumulative added image by sequentially adding (cumulatively adding) respective captured images while storing captured images corresponding to pixel signals output from the image sensor (the image sensor 100 in the first preferred embodiment) in the DRAM. Then, it is possible to sequentially display the display images corresponding to generated cumulative added images on the display device (the display device 401 in the first preferred embodiment) provided in the image pickup device (the image pickup device 10 in the first preferred embodiment). Thereby, using the image pickup device of the mode for carrying out the present invention, the photographer can check an exposure level while photographing according to the bulb photographing function of the image pickup device and easily determine a timing at which the shutter is released in the bulb photographing.

In addition, according to a mode for carrying out the present invention, captured images corresponding to pixel signals output from the image sensor or combined image data generated by the combining unit are stored in the DRAM. Thereby, in the image pickup device of the mode for carrying out the present invention, it is possible to implement an image pickup device which generates a recorded added image (an image of long-term exposure) recorded in the bulb photographing obtained by adding captured images or combined image data stored in the DRAM after photographing according to the bulb photographing function has ended. Then, it is possible to sequentially display the display images corresponding to generated recorded added images on the display device provided in the image pickup device. Thereby, using the image pickup device of the mode for carrying out the present invention, the photographer can check an exposure level of a generated recorded added image and determine a recorded added image of a desired exposure level as an image to be ultimately recorded.

In addition, according to the mode for carrying out the present invention, combined image data of captured images corresponding to pixel signals output from the image sensor by photographing according to the bulb photographing function of the image pickup device is stored in the DRAM. Thus, it is possible to change the exposure level of a generated recorded added image. Thereby, even when the shutter timing in the photographing according to the bulb photographing function is deviated from an intended exposure point, the photographer using the image pickup device of the mode for carrying out the present invention can obtain an image of a desired exposure level without performing the photographing of the bulb photographing function again.

Also, in the first preferred embodiment, the combining unit 225, for example, processes a captured image of a current frame and a captured image of a previous frame at the same timing. Incidentally, another method of synchronizing timings of a captured image of a current frame acquired and output by the image capturing I/F unit 210 at a timing at which a pixel signal is output from the image sensor 100 and a captured image of a previous frame acquired (read) by the input DMA unit 241 or 242 from the DRAM 501 is also possible. This is a method in which the CPU 600 controls a timing at which the input DMA unit 241 acquires (reads) a captured image of a previous frame. However, it is not easy for the CPU 600 to control a timing at which the input DMA unit 241 or 242 acquires (reads) and outputs a captured image of a previous frame as the same timing as that of a captured image of a current frame in which the image capturing I/F unit 210 acquires and outputs a pixel signal output from the image sensor 100 in real time. In the image pickup device 10 of the first preferred embodiment, the delay units 223a to 223c or the delay units 224a to 224c are provided within the pre-processing unit 220. Thereby, it is possible to easily set the timing of a captured image of a previous frame as the same timing as a timing of a captured image of a current frame which is acquired and output in real time. Through this configuration, two pieces of image data to be used in the combining process at the same timing are input to the combining unit 225. Thus, the combining unit 225 can perform a process of combining a captured image of a current frame acquired and output by the image capturing I/F unit 210 at a different timing and a captured image of a previous frame acquired (read) and output by the input DMA unit 241 or 242 from the DRAM 501.

Then, in the first preferred embodiment, this configuration is used even when a recorded added image is generated after photographing according to the bulb photographing function has ended. However, two captured images to be used to generate the recorded added image together constitute image data to be stored in the DRAM 501. Thus, a process in which the CPU 600 acquires (reads) and outputs two captured images at the same timing by controlling the input DMA units 241 and 242 is facilitated. Accordingly, in generation of a recorded added image after photographing according to the bulb photographing function has ended, a method that does not use the delay units 223a to 223c or the delay units 224a to 224c within the pre-processing unit 220 is also possible. Thus, a configuration for inputting each captured image to the combining unit 225 without involving the delay units 223a to 223c or the delay units 224a to 224c may be provided in the pre-processing unit 220. As this configuration, for example, a configuration in which the selector 221 adds the combining unit 225 as an output destination of image data input from the input DMA units 241 and 242 or the like is possible. Thereby, it is possible to shorten a time necessary to generate a recorded added image after photographing according to the bulb photographing function has ended.

Also, for example, even when timings at which a captured image of a current frame acquired and output by the image capturing I/F unit 210 in real time and a captured image of a previous frame stored in the DRAM 501 are acquired (read) and output by the input DMA unit 241 or 242 can be configured to be input to the combining unit 225 without involving the delay units 223a to 223c or the delay units 224a to 224c.

Also, the case in which the three delay units 223a to 223c and the three delay units 224a to 224c corresponding to the processing units 222a to 222c provided within the pre-processing unit 220 are provided and each delay unit delays input image data by the same time as a delay time from an input to an output of a corresponding processing unit and outputs the delayed image data has been described in the first preferred embodiment. However, the configuration of the delay unit is not limited to the mode for carrying out the present invention. For example, in place of the delay units 223a to 223c or the delay units 224a to 224c, only one delay unit can be configured to delay the input image data by the same time as a sum delay time of pre-processing (correction processes) by the processing units 222a to 222c and output the delayed image data. In addition, for example, in place of the delay units 223a to 223c or the delay units 224a to 224c, the processing units 222a to 222c can be configured to be provided.

In addition, the case in which one combining unit 225 is provided within the pre-processing unit 220 has been described in the first preferred embodiment. However, the configuration within the pre-processing unit 220 is not limited to the mode for carrying out the present invention. For example, when a plurality of (for example, 2) pieces of combined image data (cumulative added images or recorded added images) are simultaneously generated by combining a captured image of a current frame and a captured image of a previous frame or combining captured images of previous frames, a configuration including a plurality of (for example, 2) combining units within the pre-processing unit 220 can also be made. In this case, according to the number of combining units provided within the pre-processing unit 220 or the number of pieces of simultaneously generated combined image data, the number or configuration of input DMA units or output DMA units provided in the image capturing processing unit 200 may be appropriately changed.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An image pickup device comprising:
an image data interface (I/F) unit configured to output image data corresponding to a pixel signal input from a solid-state image pickup device as first image data;
a first image data writing unit configured to cause a storage unit to store image data based on the first image data via a data bus;
a first image data reading unit configured to read the image data stored in the storage unit via the data bus and output the read image data as second image data;
an image combining unit configured to generate and output third image data by combining two pieces of input image data;
a second image data writing unit configured to cause the storage unit to store the third image data via the data bus; and
a display unit configured to read the image data stored in the storage unit from the storage unit via the data bus and display an image corresponding to the read image data.

2. The image pickup device according to claim 1, wherein,
after an instruction to start image capturing by the solid-state image pickup device has been issued, the image data I/F unit sequentially outputs a plurality of pieces of the first image data corresponding to pixel signals of respective frames sequentially input from the solid-state image pickup device,
the first image data writing unit is configured to cause the storage unit to sequentially store image data based on the first image data of the respective frames sequentially output from the image data I/F unit,
the first image data reading unit is configured to sequentially read the third image data, which is generated by the image combining unit and ultimately stored by the second image data writing unit in the storage unit, continuous to image data based on the first image data of a first frame stored in the storage unit, as the second image data,
the image combining unit is configured to sequentially output the third image data obtained by sequentially adding and combining image data based on the first image data sequentially output from the image data I/F unit and image data based on the second image data sequentially read by the first image data reading unit,
the second image data writing unit is configured to cause the storage unit to sequentially store the third image data sequentially output from the image combining unit, and
the display unit is configured to sequentially display images corresponding to the third image data generated by the image combining unit and stored by the second image data writing unit in the storage unit.

3. The image pickup device according to claim 2, further comprising:
a second image data reading unit configured to read image data, which is different from the image data read by the first image data reading unit from the storage unit, from the storage unit via the data bus and output the read image data as fourth image data, wherein
the storage unit is configured to store image data based on the first image data of all frames sequentially output from the image data I/F unit during a period in which the solid-state image pickup device has performed image capturing and sequentially stored by the first image data writing unit, and
after an instruction to stop image capturing by the solid-state image pickup device has been issued,
the first image data reading unit reads image data based on the first image data of one frame stored in the storage unit as the second image data,
the second image data reading unit reads image data based on the first image data of the next frame of the image data based on the first image data read by the first image data reading unit or the third image data generated by the image combining unit and ultimately stored by the second image data writing unit in the storage unit as the fourth image data,
the image combining unit outputs the third image data obtained by adding and combining image data based on the second image data read by the first image data reading unit and image data based on the fourth image data read by the second image data reading unit, and
the display unit displays an image corresponding to the third image data generated by the image combining unit and stored by the second image data writing unit in the storage unit.

4. The image pickup device according to claim 2, further comprising:
a second image data reading unit configured to read image data, which is different from the image data read by the first image data reading unit from the storage unit, from the storage unit via the data bus and output the read image data as fourth image data, wherein,
when an instruction to stop image capturing by the solid-state image pickup device has been issued, the storage unit stores image data based on the first image data of a frame output from the image data I/F unit and stored in the storage unit, image data based on the first image data of a predetermined number of frames output from the image data I/F unit and stored in the storage unit in periods before and after the image capturing stop instruction has been issued, and the third image data obtained by the image combining unit sequentially combining image data from image data based on the first image data of a first frame stored in the storage unit after the instruction to start the image capturing by the solid-state image pickup device has been issued to image data based on the first image data of a frame one frame before a predetermined number of frames in a period before the instruction to stop the image capturing is issued, and
after the instruction to stop the image capturing by the solid-state image pickup device has been issued,
the first image data reading unit reads image data based on the third image data stored in the storage unit or the first image data of one frame as the second image data,
the second image data reading unit reads image data based on the first image data of a first frame stored in the storage unit or image data based on the first image data of the next frame of image data based on the first image data read by the first image data reading unit as the fourth image data,
the image combining unit outputs the third image data obtained by adding and combining image data based on the second image data read by the first image data reading unit and image data based on the fourth image data read by the second image data reading unit, and
the display unit displays an image corresponding to the third image data generated by the image combining unit and stored by the second image data writing unit in the storage unit.

5. The image pickup device according to claim 2, further comprising:
a second image data reading unit configured to read image data, which is different from image data read by the first image data reading unit from the storage unit, from the storage unit via the data bus and output the read image data as fourth image data, wherein
the storage unit is configured to store the third image data obtained by the image combining unit sequentially combining image data from image data based on the first image data of a first frame stored in the storage unit after an instruction to start image capturing by the solid-state image pickup device has been issued to image data based on the first image data of a frame output from the image data I/F unit and stored in the storage unit when an instruction to stop the image capturing by the solid-state image pickup device has been issued and the third image data of a predetermined number of frames obtained by the image combining unit sequentially combining image data from image data based on the first image data of the first frame to image data based on the first image data of the predetermined number of frames output from the image data I/F unit and stored in the storage unit in periods before and after the instruction to stop the image capturing has been issued, and
after the instruction to stop the image capturing by the solid-state image pickup device has been issued,
the first image data reading unit reads the third image data of one frame stored in the storage unit as the second image data,
the second image data reading unit reads the third image data of a different frame from that of the third image data read by the first image data reading unit as the fourth image data,
the image combining unit outputs the third image data obtained by subtracting and combining image data based on the second image data read by the first image data reading unit and image data based on the fourth image data read by the second image data reading unit, and
the display unit displays an image corresponding to the third image data stored in the storage unit or an image corresponding to the third image data generated by the image combining unit and stored by the second image data writing unit in the storage unit.

6. The image pickup device according to claim 3, further comprising:
a first pre-processing unit configured to perform a predetermined process on input image data;
a second pre-processing unit configured to perform a predetermined process on input image data; and
a third pre-process unit configured to perform a predetermined process on input image data and has the same configuration as the second pre-processing unit, wherein
the first pre-processing unit is configured output image data obtained by performing the predetermined process on the input first image data as image data based on the first image data,
the second pre-processing unit is configured to output image data obtained by performing the predetermined process on the input second image data as image data based on the second image data, and
the third pre-processing unit is configured to output image data obtained by performing the predetermined process on the input fourth image data as image data based on the fourth image data.

7. The image pickup device according to claim 6, wherein
the first pre-processing unit is at least one processing unit which performs a predetermined correction process on input image data, and
the second and third pre-processing units include at least one delay unit which performs a process of delaying input image data by a predetermined time and outputting the delayed input image data.

8. The image pickup device according to claim 7, wherein the predetermined time is the same as a delay time until an output obtained by performing the predetermined correction process is generated after image data is input to the first pre-processing unit.

9. The image pickup device according to claim 6, wherein
the first pre-processing unit is at least one first processing unit which performs a predetermined correction process on input image data, and
the second and third pre-processing units include at least one second processing unit which performs a predetermined correction process on input image data.

10. The image pickup device according to claim 1, further comprising:
a plurality of image combining units, each of which is configured to simultaneously generate and output corresponding third image data obtained by combining two pieces of input image data.
